(19) United States
(12) Patent Application Publication
(10) Pub. No.: US 2011/0213651 A1
(43) Pub. Date: Sep. 1, 2011

(54) Computer-Implemented Method For Enhancing Targeted Product Sales

(75) Inventors: Joseph Milana, San Diego, CA (US); Bo Zhang, San Diego, CA (US)

(73) Assignee: OPERA SOLUTIONS, LLC, Jersey City, NJ (US)

(21) Appl. No.: 12/715,248

(22) Filed: Mar. 1, 2010

(51) Int. Cl. G06Q 30/00; G06N 5/02; G06Q 10/00

(52) U.S. Cl. 705/14.25; 706/52

(57) ABSTRACT

A computer-implemented method for providing customer recommendations for a product is disclosed. For each target product for which a customer recommendation is desired, one or more customers likely to purchase the target product are identified using a mathematical model that considers customers' prior purchases of products that are similar or related to the target product.

### CROSS REFERENCE TO RELATED APPLICATIONS

This patent relates to co-filed patent application Ser. No. ______, entitled COMPUTER-IMPLEMENTED METHOD FOR ENHANCING PRODUCT SALES and is incorporated by reference herein.

### FIELD OF THE INVENTION

The present invention relates to a computer-implemented marketing method for enhancing the sales of products and/or services and, more particularly, to a method that recommends customers likely to purchase specified products and/or services based on previous purchases of customers.

### BACKGROUND OF THE INVENTION

Businesses today are under ever-increasing pressures to increase product sales and enhance profitability. A variety of techniques, such as product promotions, discounts, coupon offerings and the like have long been used to promote product sales including sales of new products. While such techniques have proved beneficial, there are costs associated with such promotions, such as providing and distributing product coupons, advertisements and the like. In addition, the promotions tend to be applied across broad segments of a customer base and are not tailored to any particular customer or customers likely to purchase the products.

It has long been considered desirable to develop and implement a computer-based method that would identify those customers who are predicted to desire new products or products not before purchased by that customer, if properly presented. To this end, such product promotions would be individually tailored for each customer and may not entail the costs associated with prior art product promotions.

### SUMMARY OF THE INVENTION

The present invention overcomes the limitations of the prior art by providing a marketing method that processes existing customer data to provide specific customer recommendations for a product. Each customer recommendation is for a particular product, hereinafter “the target product”, and identifies recommended one or more customers, hereinafter “the target customers”, likely to purchase the target product. The present invention uses a mathematical model, e.g., neural network model, that considers customers' prior purchases of products including those products that are similar or related to the target product. The output of the mathematical model is used to select and optionally rank the target customers from a pool of customers.

The present invention includes the method of training the mathematical model, which may include collecting data, including the frequency of prior product purchases by customers, then normalizing that data across the customer population. The normalized data may be input into the mathematical model, which may be trained to learn customers' likes and dislikes based on those prior purchases. During training, the mathematical model may attempt to determine estimated purchase tendencies of products (for which there is a known tendency) based on purchase tendencies of related products. The model may then test the estimated tendency against the known tendency and adjust accordingly. The present invention uses the concept of a tiered hierarchy to classify products. The tiered hierarchy is used both in training the model and when using the model to identify target customers. Advantageously, the disclosed technique is particularly suitable for use in “door-to-door” product sales.

### BRIEF DESCRIPTION OF THE DRAWINGS

For a better understanding of the present invention, reference is made to the following description and accompanying drawings, while the scope of the invention is set forth in the appended claims:

FIG. 1 is a representative block diagram of sequential steps carried out in accordance with an embodiment of the present invention;

FIG. 2 is an exemplary table showing customers, products purchased and purchase frequencies;

FIG. 3 is an exemplary table showing purchase percentiles corresponding to purchase frequency for one product illustrated in FIG. 2;

FIG. 4 is an exemplary table showing purchase frequencies and purchase percentiles for a product and its hierarchy based on FIGS. 2 and 3;

FIG. 5 is an exemplary table showing purchase frequencies and purchase percentiles for model training based on FIGS. 2-4;

FIG. 6 is an exemplary block diagram of computer apparatus useable to carry out the methodology of the present invention.

### DETAILED DESCRIPTION

For purposes of this patent application, the term “products” shall hereinafter mean products and/or services. In addition, the notion of “sales” includes any form of product transfer from a product seller or offeror to a product purchaser or offeree wherein the purchaser acquires the right to use or consume a product in exchange for some consideration given to the seller by the purchaser. This benefit to the seller is generally in the form of money, but can take other non-monetary forms. Accordingly, the notion of sales and purchases includes, includes all forms of product transfers including but not limited to all forms of sales, leases, barters, or the like.

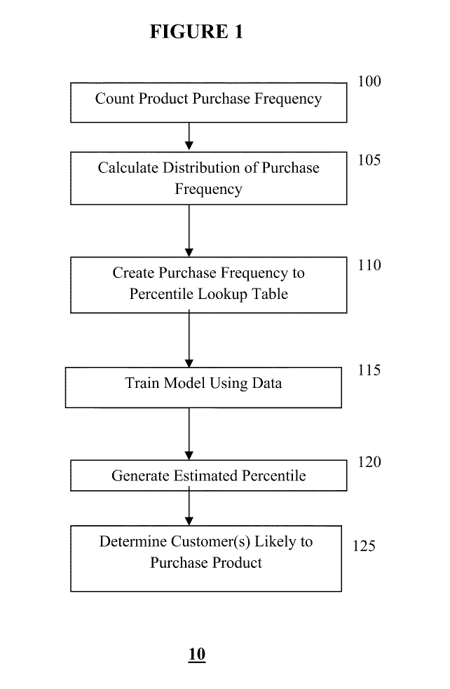

An illustrative embodiment of the present invention will be described with respect to a seller having a computer-implemented database. This database includes previous product purchases for each customer. It is also assumed that the seller offers products spanning a number of different product categories. In the embodiment of FIG. 1, each customer in the customer database may be a target customer. In accordance with the method of the present invention, an analysis of the data, for example, of each customer is performed to determine a listing of one or more customers who may purchase a target product, and optionally the likelihoods of those customers for purchasing such product. It should, of course, be understood that the present invention is not limited to providing a recommendation for a single product and, instead, can provide a recommendation for any desired subset of products in the database.

FIG. 1 depicts a block diagram of a representative method 10 in accordance with the invention. As shown in FIG. 1, in step 100, the method 10 accesses the database and for each product, determines respective purchase frequencies, which is the number of occasions corresponding customers have purchased that product in a predetermined time period. Products may be identified by name, stock-keeping-unit codes (SKUs) or other identifiers. A time period for this step may be measured in days, weeks, months or years.

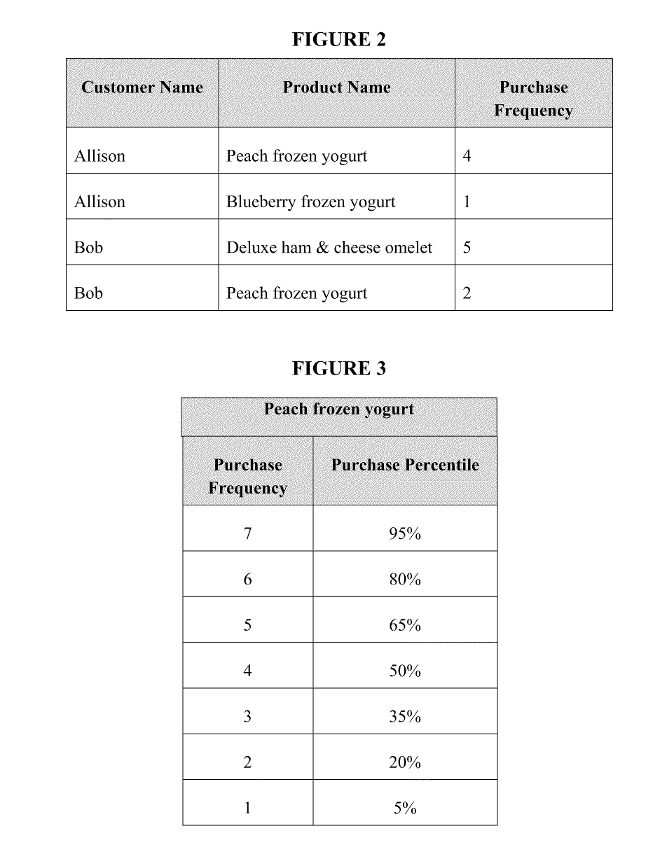

In one non-limiting example shown in FIG. 2, results of step 100 show customer “Allison” purchased a “peach frozen yogurt” product on four occasions in the past year. The counting operation of step 100 may be repeated for each customer who purchased the product in the time period, or other operations or algorithms for counting product purchase frequency may be used in accordance with the invention. As shown in FIG. 2, customer “Bob” purchased “peach frozen yogurt” on two occasions in the past year.

Optionally, the quantity of the product purchased may be incorporated in the analysis.

Optionally, it may be advantageous to exclude from the results of step 100 those, customers who have purchased on fewer than a predetermined number of occasions in the time period, for example, on less than three (3) occasions in one year.

Then, at step 105, the distribution of purchase percentiles based on purchase frequency are calculated for a product. This process is known as “normalization” and may be performed using known statistical analytical methods. At step 110, a lookup table is generated showing purchase frequency and corresponding purchase percentiles for a product. Continuing this example, FIG. 3 shows such a lookup table with purchase frequency and corresponding percentiles for “peach frozen yogurt” product.

The present invention may advantageously employ a hierarchical structure to organize products. For example, a four-tiered structure may be as follows, in order from highest/broadest to lowest/narrowest: category, family, sub-family, and product (SKU). Continuing our example, the product “peach frozen yogurt” may be in sub-family “frozen yogurt”, family “half-gallons sq/round”, and category “ice cream”. It will be understood that other structures may be used including those with greater or fewer tiers. Purchase frequency lookup tables for sub-families, families, and categories of products may be generated in a similar manner as above.

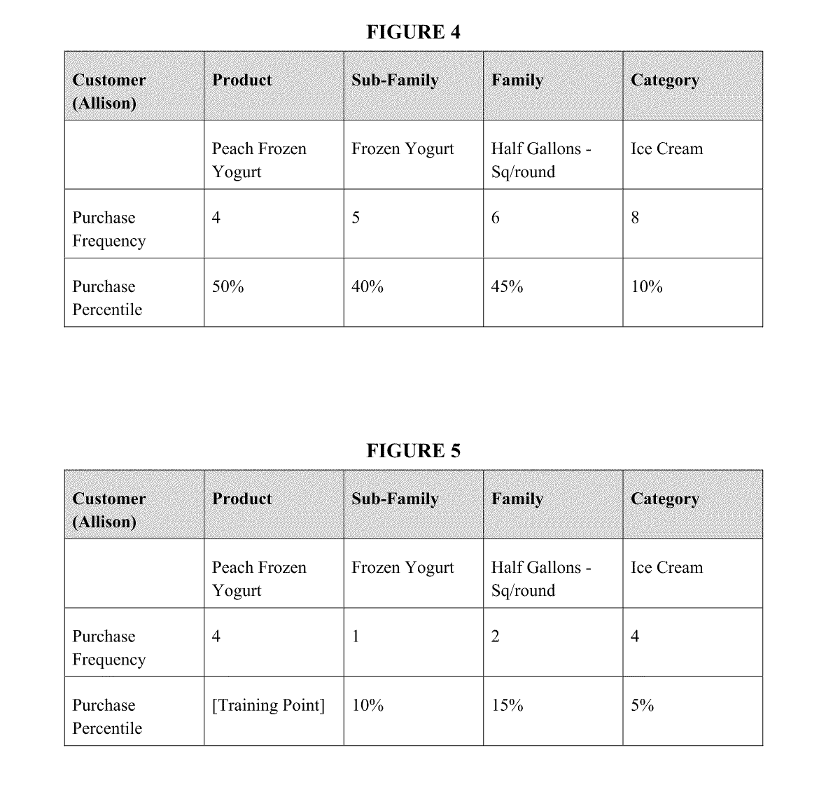

Steps 100 and 105 may be implemented or repeated for all products in a category with purchase frequency information, and resultant corresponding purchase percentiles for products, sub-families, families, and categories stored in, for example, the previously discussed database. FIG. 4 is a table showing the purchase frequency and corresponding purchase percentile for customer “Allison” for the product “peach frozen yogurt” and its sub-family, family, and category for that product. As previously discussed with regard to FIG. 2, Allison purchased the product “peach frozen yogurt” on four occasions in the past year. As shown in FIG. 3, purchases of the product “peach frozen yogurt” on four occasions in the past year (purchase frequency=4) corresponds to the 50^{th} percentile of purchasers of that product. Therefore, Allison is in the 50^{th} purchase percentile of purchasers of that product, as shown in FIG. 4.

Further, because purchase frequencies and purchase percentiles have been determined for all products in a category, FIG. 4 shows that data for the sub-family, family, and category. For example, as shown in FIG. 1, Allison purchased the product “blueberry frozen yogurt” on one occasion in the past year. Assuming the product “blueberry frozen yogurt” is in the sub-family “frozen yogurt”, then Allison's purchase frequency for sub-family “frozen yogurt” is 5, which corresponds to the 40^{th} percentile of purchasers of products in that sub-family as shown in FIG. 4. The purchase frequency tables for sub-family, family, and category are not shown.

Then, in step 115, a model is trained using products, hierarchy, and purchase percentiles. One type of model suitable for use with the present invention is a feed-forward artificial neural network, trained using back-propagation. Other types of statistical models may be used, such as simple linear regression or Support Vector Machines.

In one aspect of the invention of the present disclosure, the neural network may be trained by causing the neural network to estimate the purchase percentile for a chosen product for a customer based on modified purchase percentiles for that product's sub-family, family, and category. As shown in FIG. 5 and described in more detail below, the chosen product's sub-family, family, and category purchase frequency may be modified by subtracting the purchase frequency of the chosen product. Continuing the example, as shown in FIG. 5, purchase frequencies for sub-family, family, and category have each been reduced by “4”, the purchase frequency of the chosen product, “peach frozen yogurt”. Modified purchase percentiles based on the newly reduced purchase frequencies for the sub-family, family, and category are computed and used for training.

In this example, the neural network may be trained by causing the neural network to determine the purchase percentile for “peach frozen yogurt” for customer Allison whose modified purchase percentiles in that product's sub-family (“frozen yogurt”) are 10%, family (“half gallons sq/round”) 15% and category (“ice cream”)5%. The product selected for training may be chosen specifically or randomly.

Once trained, in step 120 the neural network may generate an output by calculating predicted purchase percentiles for products that customers have never purchased or have not purchased in a time period. This may involve scoring using the trained model.

Then, in step 125, the method 10 determines, for a given product, one or more customers likely to purchase the product. One way to make such determination is to identify customers with the highest purchase frequency or highest predicted purchase frequency for this product. If a customer has purchased this product in the time period, then the method may advantageously use the purchase frequency for that customer and product in this determination and may not use the neural network prediction. Continuing the example, if the method is determining customers likely to purchase “Peach Frozen Yogurt” product, then the method 10 will use Allison's 50% purchase percentile shown in FIG. 4, in that analysis because Allison has purchased that product in the time period.

Otherwise, if a customer has not purchased this product in the time period, then the method may use the neural network predicted purchase percentile, and correspondingly convert that predicted purchase percentile to purchase frequency using a table such as shown in FIG. 3.

The method 10 may select target customers for products. In one aspect, given a list of targeted products, which may be geographically specific, choose for each customer that targeted product with the highest percentile (or alternatively purchase frequency); then balance supply constraints of the targeted product by excluding from the target list those products that have gone past their specified constraints. One example of a supply constraint is a quantity of a product available in a geographic region. In one aspect, the method 10 may limit the number of target customers selected in a region based on the quantity of available product in that region. In one example, the method 10 may make two to three times as many offers as quantity of product available to account for the fact that every recommendation may not lead to a purchase.

In another aspect, the method 10 may perform a product level optimization choosing the customers with the highest purchase frequency by solving a linear programming problem, which may be a lambda-assignment problem. In this optimization, the method 10 may seek to maximize the expected percentile summed across all products offered given capacity constraints of each product, which may typically be multiplied by a factor of 2 or 3 to account for the fact that not all recommendations may be actually converted to sales. The method may calculate an expected conversion rate for each customer and then multiply each predicted percentile for the customer with the expected conversion rate and seek to optimize this combined quantity. This may require having an accumulated history of responses to recommendations to build the response model, which may be present.

For products that have no or few purchases, such as a new product, then the product's purchase frequency may be replaced by the corresponding purchase frequency of the product's sub-family, family or category.

The method 10 may identify the most likely customers overall or may identify the most likely customers within a subset of customers. Subsets may be determined by location of customers, sales information for customers, or targeting customers based on purchases of higher profit margin products.

Once the potential customers have been determined, the invention of the present disclosure is readily useable to recommend new or existing products to those customers.

The method of the present invention is useable to recommend customers based on a determination that the customer is likely to purchase a new product. A new product may be a product that has not yet been sold or offered for sale. Such a new product determination can be made based on a diversity of the customer's purchases, i.e., the number of different products purchased by the customer and the respective product quantities. For example, a customer who purchases a large quantity of a small selection of products may be less likely to purchase a new product than a customer who purchases a smaller quantity of a variety of products. The customer's product diversity information, including product types and quantities may be input into the neural network to assist determining whether to offer the new product to the customer. The customer's product diversity information may be used in connection with existing (non-new) products as well. A new product determination may be based on the frequency in which a customer has bought from the new product's sub-family, family, and category.

It should be understood that the method of this invention is particularly suitable for implementation using a computer or computer system as described in more detail below.

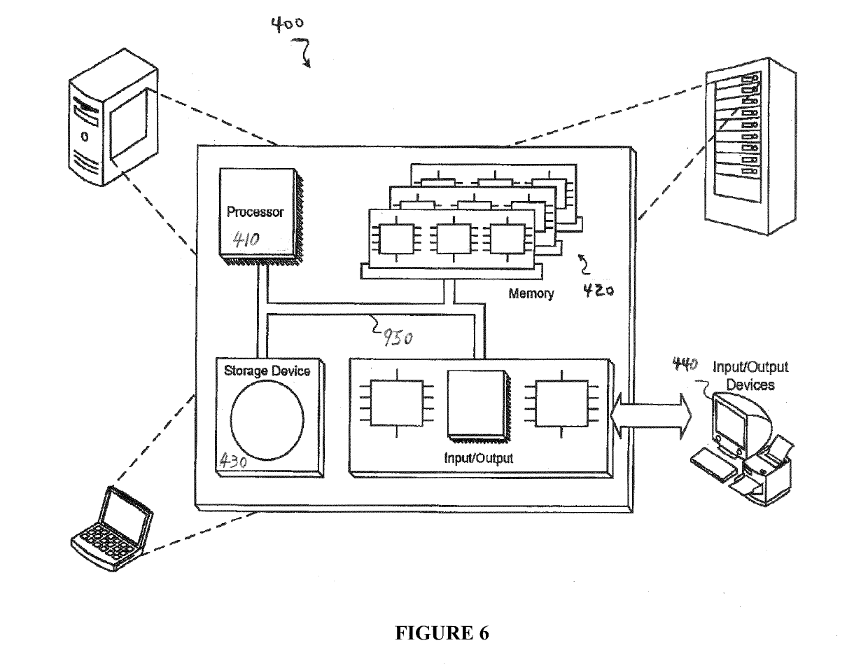

Refer now to FIG. 6, which shows an illustrative computer system 400 suitable for implementing the present invention. Computer system 400 includes processor 410, memory 420, storage device 430 and input/output devices 440. Some or all of the components 410, 420, 430 and 440 may be interconnected by a system bus 950. Processor 410 may be single or multi-threaded and may have one or more cores. Processor 410 executes instructions which in the disclosed embodiments of the present invention are the steps described and shown in FIGS. 1 and 3. These instructions are stored in memory 420 or in storage device 430. Information may be received and output using one or input/output devices 440.

Memory 420 may store information and may be a computer-readable medium, such as volatile or non-volatile memory. Storage device 430 may provide storage for system 400 including for the example, the previously described database, and may be a computer-readable medium. In various aspects, storage device 430 may be a flash memory device, a floppy disk drive, a hard disk device, and optical disk device, or a tape device.

Input devices 440 may provide input/output operations for system 400. Input/output devices 440 may include a keyboard, pointing device, and microphone. Input/output devices 440 may further include a display unit for displaying graphical user interfaces, a speaker and a printer. As shown the computer system 400 may be implemented in a desktop computer, or in a laptop computer, or in a server. The recommendations provided pursuant to the present invention can be provided on a computer display proximate to the computer system 900 or remote from such system and communicated wirelessly to a sales person's mobile communication device. In this manner, the recommendation can be personally presented to the target customer when such customer is visited by the seller's sales person. Alternatively, the recommendations for each target customer can be provided in mass to the seller for redistribution to the appropriate sales person that interacts with that target customer.

It should of course, be understood that while the present invention has been described with respect to disclosed embodiments, numerous variations are possible without departing from the spirit and scope of the present invention. Finally, while recommendations in the disclosed embodiments are customers, the term customer may be an individual, a group of individuals, such as a family a club ort social group or a company.

1. A computer implemented method for identifying one or more target customers to offer a target product, the method comprising the steps of:
a) calculating actual purchase percentiles based on actual purchase frequencies of products;
b) training a model using the actual purchase percentiles;
c) calculating, using the model and the actual purchase percentiles, predicted purchase percentiles for the target product for customers;
d) calculating predicted purchase frequencies for the target product based on the predicted purchase percentiles; and
e) identifying one or more target customers based on actual and predicted purchase frequencies for the target product.

2. The computer implemented method of claim 1, wherein the actual purchase frequencies of products are determined for each product purchased by each customer within a predetermined time period.

3. The computer implemented method of claim 1, wherein the actual purchase frequencies of products are determined for each product purchased by each customer who purchases products at greater than a predetermined frequency.

4. The computer implemented method of claim 1, wherein the actual purchase percentiles and corresponding actual purchase frequencies are linked and stored in memory.

5. The computer implemented method of claim 1, wherein step b) further comprises: requesting the model to determine a purchase percentile that is known for a product, based on the actual purchase percentiles for related products.

6. The computer implemented method of claim 1, wherein products are categorized in a tiered hierarchy as follows: product, sub-family, family, and category, and wherein step b) further comprises requesting the model to determine a purchase percentile that is known for a specified product, based on the actual purchase percentiles for products in at least the same sub-family as the specified product.

7. The computer implemented method of claim 1, wherein products are categorized in a tiered hierarchy as follows: product, sub-family, family, and category, and wherein step d) further comprises assigning to a target product the predicted purchase frequency of the sub-family for the target product.

8. The computer implemented method of claim 1, wherein step e) further comprises using actual purchase frequencies when present for customers, otherwise using predicted purchase frequencies.

9. The computer implemented method of claim 1, wherein step e) further comprises identifying target customers with highest likelihood of purchasing the target product based on actual and predicted purchase frequencies for the target product.

10. The computer implemented method of claim 1, wherein step e) further comprises identifying a predetermined number of target customers within a subset of customers.

11. A computer program product, comprising a computer usable medium having a computer readable program code embodied therein, the computer readable program code adapted to be executed to implement a method for identifying one or more target customers to offer a target product, the method comprising:
a) calculating actual purchase percentiles based on actual purchase frequencies of products;
b) training a model using the actual purchase percentiles;
c) calculating, using the model and the actual purchase percentiles, predicted purchase percentiles for the target product for customers;
d) calculating predicted purchase frequencies for the target product based on the predicted purchase percentiles; and
e) identifying one or more target customers based on actual and predicted purchase frequencies for the target product.

12. The computer program product of claim 11, wherein the actual purchase frequencies of products are determined for each product purchased by each customer within a predetermined time period.

13. The computer program product of claim 11, wherein the actual purchase frequencies of products are determined for each product purchased by each customer who purchases products at greater than a predetermined frequency.

14. The computer program product of claim 11, wherein the actual purchase percentiles and corresponding actual purchase frequencies are linked and stored in memory.

15. The computer program product of claim 11, wherein step b) further comprises: requesting the model to determine a purchase percentile that is known for a product, based on the actual purchase percentiles for related products.

16. The computer program product of claim 11, wherein products are categorized in a tiered hierarchy as follows: product, sub-family, family, and category, and wherein step b) further comprises requesting the model to determine a purchase percentile that is known for a specified product, based on the actual purchase percentiles for products in at least the same sub-family as the specified product.

17. The computer program product of claim 11, wherein products are categorized in a tiered hierarchy as follows: product, sub-family, family, and category, and wherein step d) further comprises assigning to a target product the predicted purchase frequency of the sub-family for the target product.

18. The computer program product of claim 11, wherein step e) further comprises using actual purchase frequencies when present for customers, otherwise using predicted purchase frequencies.

19. The computer program product of claim 11, wherein step e) further comprises identifying target customers with highest likelihood of purchasing the target product based on actual and predicted purchase frequencies for the target product.

20. The computer program product of claim 11, wherein step e) further comprises identifying a predetermined number of target customers within a subset of customers.
